(19) United States
(12) Patent Application Publication
(10) Pub. No.: US 2018/0068039 A1
(43) Pub. Date: Mar. 8, 2018

(54) METHOD AND APPARATUS FOR ENHANCED MODELING AND ANALYSIS OF MATERIALS

(71) Applicant: KING ABDULLAH UNIVERSITY OF SCIENCE AND TECHNOLOGY, THUWAL (SA)

(72) Inventors: Amal Aboulhassan, Thuwal (SA); Markus Hadwiger, Thuwal (SA)

(21) Appl. No.: 15/551,976

(22) PCT Filed: Feb. 18, 2016
(86) PCT No.: PCT/IB2016/050882

§ 371 Date: Aug. 18, 2017

Related U.S. Application Data
(60) Provisional application No. 62/117,582, filed on Feb. 18, 2015.

(51) Int. Cl. G06F 17/50; G06T 15/00; G06T 15/20

(52) U.S. Cl. CPC G06F 17/5009; G06T 2210/56; G06T 15/205; G06T 15/005

(57) ABSTRACT

A method, apparatus, and computer readable medium are provided for modeling of materials and visualization of properties of the materials. An example method includes receiving data describing a set of properties of a material, and computing, by a processor and based on the received data, geometric features of the material. The example method further includes extracting, by the processor, particle paths within the material based on the computed geometric features, and geometrically modeling, by the processor, the material using the geometric features and the extracted particle paths. The example method further includes generating, by the processor and based on the geometric modeling of the material, one or more visualizations regarding the material, and causing display, by a user interface, of the one or more visualizations.

### TECHNOLOGICAL FIELD

Example embodiments of the present invention relate generally to materials science and, more particularly, to visualization software improving the analysis of materials.

### BACKGROUND

Materials scientists need better modeling tools for the analysis of new materials whose designs are correlated to the path features of the particles flowing inside. In this regard, because particle path features influence particle behavior within a material, improved knowledge of particle path features is a critical tool for guiding the choices used to design the materials themselves.

Materials scientists currently depend on lab tools for modeling and analyzing new materials. However, these tools have three limitations: (1) they are time consuming; (2) they are expensive; and (3) they fail to provide insight regarding the path features of the materials being studied. At the same time, materials scientists historically have been unable to depend on computer simulations, due to one or more of the following obstacles: (1) traditional simulation software lacks sufficient knowledge to build accurate simulations; (2) traditional simulation software is unable to merge the multi-disciplinary concepts that must be evaluated in the material science field; and (3) the generation of computer simulations has traditionally been too time consuming to enable interactive exploration or to operate using big data.

The design of a visual paradigm that can overcome the above obstacles is not straightforward because, heretofore, the following have not existed: (1) a scientifically valid method of knowledge-based extraction of particle paths; (2) a set of structure features that correlate to these particle paths (when extracted); (3) visualization modules that support this type of data and their analysis; and (4) computing techniques that are efficient enough to enable computer systems to support interactive exploration of these particle paths and their correlations to the extracted structure features.

### BRIEF SUMMARY

Embodiments described herein provide visualization tools that overcome the above defects and that can be used to enhance the modeling and analysis of materials. In particular, embodiments described herein are able to enhance the modeling and analysis of materials whose design is correlated to the path features of the particles flowing inside.

In a first example embodiment, a method is provided. The method includes receiving data describing a set of properties of a material, and computing, by a processor and based on the received data, geometric features of the material. The method further includes extracting, by the processor, particle paths within the material based on the computed geometric features, and geometrically modeling, by the processor, the material using the geometric features and the extracted particle paths. The method then includes generating, by the processor and based on the geometric modeling of the material, one or more visualizations regarding the material, and causing display, by a user interface, of the one or more visualizations.

In some embodiments, receiving data describing the material may include receiving a data file including information describing geometric characteristics of the material, wherein computing the geometric features of the material is based on the received data file. In other embodiments, receiving data describing the material may include receiving user input regarding at least one property of the set of properties of the material, wherein computing the geometric features of the material is based on the received user input.

In some embodiments, computing the geometric features of the material may include at least one of: generating a distance map between geometric features of the material; generating a two dimensional segmentation representing geometric features of the material; generating a three dimensional segmentation representing geometric features of the material; generating a morphology backbone data structure that identifies geometric features of the material; or identifying cross-sectional areas comprising geometric features of the material.

In some embodiments, extracting the particle paths may include generating a graph structure including nodes representative of the geometric features of the material, and computing a set of shortest paths between nodes in the graph structure, wherein the particle paths comprise the set of shortest paths between the nodes. Additionally or alternatively, geometrically modeling the material may include deriving at least one set of direct features of the material, and generating correlational models illustrating properties of the material. To this end, deriving the at least one set of direct features of the material may include at least one of: calculating lengths of particle paths within the material; calculating tortuosity of particle paths within the material; or calculating sizes of cross-sectional areas of geometric features of the material. Generating correlational models illustrating properties of the material may include at least one of: generating a bottleneck model describing bottleneck coefficients associated with cross-sections of the extracted particle paths; or generating an exciton diffusion model describing probabilities that excitons diffuse from a donor part of the material to an interface with an acceptor part of the material via the extracted particle paths.

In some embodiments, generating the one or more visualizations may include generating at least one of: a spatial graph illustrating a backbone topology; a scatter plot illustrating correlations between geometric features; or a spatial graph illustrating a particle path topology.

In some embodiments, the method may further include receiving, in response to displaying the one or more visualizations, an indication of a request from a user to modify a first visualization of the one or more visualizations, modifying the first visualization based on the received indication, and causing display, by the user interface, of the altered first visualization.

In a second example embodiment, an apparatus is provided. The apparatus includes a processor and a memory storing program code instructions that, when executed by the processor, cause the apparatus to receive data describing a set of properties of a material, and compute, based on the received data, geometric features of the material. The program code instructions, when executed by the processor, further cause the apparatus to extract particle paths within the material based on the computed geometric features, and geometrically model the material using the geometric features and the extracted particle paths. The program code instructions, when executed by the processor, further cause the apparatus to generate, based on the geometric modeling of the material, one or more visualizations regarding the material; and cause display of the one or more visualizations.

In some embodiments, receiving data describing the material may include receiving a data file including information describing geometric characteristics of the material, wherein computing the geometric features of the material is based on the received data file. In other embodiments, receiving data describing the material may include receiving user input regarding at least one property of the set of properties of the material, wherein computing the geometric features of the material is based on the received user input.

In some embodiments, the program code instructions, when executed by the processor, cause the apparatus to compute the geometric features of the material by at least one of: generating a distance map between geometric features of the material; generating a two dimensional segmentation representing geometric features of the material; generating a three dimensional segmentation representing geometric features of the material; generating a morphology backbone data structure that identifies geometric features of the material; or identifying cross-sectional areas comprising geometric features of the material.

In some embodiments, the program code instructions, when executed by the processor, cause the apparatus to extract the particle paths by generating a graph structure including nodes representative of the geometric features of the material, and computing a set of shortest paths between nodes in the graph structure, wherein the particle paths comprise the set of shortest paths between the nodes.

Additionally or alternatively, the program code instructions, when executed by the processor, may cause the apparatus to geometrically model the material by deriving at least one set of direct features of the material, and generating correlational models illustrating properties of the material. To this end, the program code instructions, when executed by the processor, may cause the apparatus to derive the at least one set of direct features of the material by at least one of: calculating lengths of particle paths within the material; calculating tortuosity of particle paths within the material; or calculating sizes of cross-sectional areas of geometric features of the material. The program code instructions, when executed by the processor, may cause the apparatus to generate correlational models illustrating properties of the material by at least one of: generating a bottleneck model describing bottleneck coefficients associated with cross-sections of the extracted particle paths; or generating an exciton diffusion model describing probabilities that excitons diffuse from a donor part of the material to an interface with an acceptor part of the material via the extracted particle paths.

In some embodiments, the program code instructions, when executed by the processor, may cause the apparatus to generate the one or more visualizations by generating at least one of: a spatial graph illustrating a backbone topology; a scatter plot illustrating correlations between geometric features; or a spatial graph illustrating a particle path topology.

In some embodiments, the program code instructions, when executed by the processor, further cause the apparatus to receive, in response to displaying the one or more visualizations, an indication of a request from a user to modify a first visualization of the one or more visualizations, modify the first visualization based on the received indication, and cause display, by the user interface, of the altered first visualization.

In a third example embodiment, a non-transitory computer readable storage medium is provided. The non-transitory computer readable storage medium stores program code instructions that, when executed by an apparatus, cause the apparatus to receive data describing a set of properties of a material, and compute, based on the received data, geometric features of the material. The program code instructions, when executed by the apparatus, further cause the apparatus to extract particle paths within the material based on the computed geometric features, and geometrically model the material using the geometric features and the extracted particle paths. The program code instructions, when executed by the apparatus, further cause the apparatus to generate, based on the geometric modeling of the material, one or more visualizations regarding the material; and cause display of the one or more visualizations.

In some embodiments, receiving data describing the material may include receiving a data file including information describing geometric characteristics of the material, wherein computing the geometric features of the material is based on the received data file. In other embodiments, receiving data describing the material may include receiving user input regarding at least one property of the set of properties of the material, wherein computing the geometric features of the material is based on the received user input.

In some embodiments, the program code instructions, when executed by the apparatus, cause the apparatus to compute the geometric features of the material by at least one of: generating a distance map between geometric features of the material; generating a two dimensional segmentation representing geometric features of the material; generating a three dimensional segmentation representing geometric features of the material; generating a morphology backbone data structure that identifies geometric features of the material; or identifying cross-sectional areas comprising geometric features of the material.

In some embodiments, the program code instructions, when executed by the apparatus, cause the apparatus to extract the particle paths by generating a graph structure including nodes representative of the geometric features of the material, and computing a set of shortest paths between nodes in the graph structure, wherein the particle paths comprise the set of shortest paths between the nodes.

Additionally or alternatively, the program code instructions, when executed by the apparatus, may cause the apparatus to geometrically model the material by deriving at least one set of direct features of the material, and generating correlational models illustrating properties of the material. To this end, the program code instructions, when executed by the apparatus, may cause the apparatus to derive the at least one set of direct features of the material by at least one of: calculating lengths of particle paths within the material; calculating tortuosity of particle paths within the material; or calculating sizes of cross-sectional areas of geometric features of the material. The program code instructions, when executed by the apparatus, may cause the apparatus to generate correlational models illustrating properties of the material by at least one of: generating a bottleneck model describing bottleneck coefficients associated with cross-sections of the extracted particle paths; or generating an exciton diffusion model describing probabilities that excitons diffuse from a donor part of the material to an interface with an acceptor part of the material via the extracted particle paths.

In some embodiments, the program code instructions, when executed by the apparatus, may cause the apparatus to generate the one or more visualizations by generating at least one of: a spatial graph illustrating a backbone topology; a scatter plot illustrating correlations between geometric features; or a spatial graph illustrating a particle path topology.

In some embodiments, the program code instructions, when executed by the apparatus, further cause the apparatus to receive, in response to displaying the one or more visualizations, an indication of a request from a user to modify a first visualization of the one or more visualizations, modify the first visualization based on the received indication, and cause display, by the user interface, of the altered first visualization.

In a fourth example embodiment, an apparatus is provided. The apparatus includes means for receiving data describing a set of properties of a material, and means for computing, based on the received data, geometric features of the material. The method further includes means for extracting particle paths within the material based on the computed geometric features, and means for geometrically modeling the material using the geometric features and the extracted particle paths. The apparatus also includes means for generating, based on the geometric modeling of the material, one or more visualizations regarding the material, and means for causing display of the one or more visualizations.

In some embodiments, the means for receiving data describing the material may include means for receiving a data file including information describing geometric characteristics of the material, wherein computing the geometric features of the material is based on the received data file. In other embodiments, the means for receiving data describing the material may include means for receiving user input regarding at least one property of the set of properties of the material, wherein computing the geometric features of the material is based on the received user input.

In some embodiments, the means for computing the geometric features of the material may include at least one of: means for generating a distance map between geometric features of the material; means for generating a two dimensional segmentation representing geometric features of the material; means for generating a three dimensional segmentation representing geometric features of the material; means for generating a morphology backbone data structure that identifies geometric features of the material; or means for identifying cross-sectional areas comprising geometric features of the material.

In some embodiments, the means for extracting the particle paths may include means for generating a graph structure including nodes representative of the geometric features of the material, and means for computing a set of shortest paths between nodes in the graph structure, wherein the particle paths comprise the set of shortest paths between the nodes. Additionally or alternatively, the means for geometrically modeling the material may include means for deriving at least one set of direct features of the material, and means for generating correlational models illustrating properties of the material. To this end, the means for deriving the at least one set of direct features of the material may include at least one of: means for calculating lengths of particle paths within the material; means for calculating tortuosity of particle paths within the material; or means for calculating sizes of cross-sectional areas of geometric features of the material. The means for generating correlational models illustrating properties of the material may include at least one of: means for generating a bottleneck model describing bottleneck coefficients associated with cross-sections of the extracted particle paths; or means for generating an exciton diffusion model describing probabilities that excitons diffuse from a donor part of the material to an interface with an acceptor part of the material via the extracted particle paths.

In some embodiments, the means for generating the one or more visualizations may include means for generating at least one of: a spatial graph illustrating a backbone topology; a scatter plot illustrating correlations between geometric features; or a spatial graph illustrating a particle path topology.

In some embodiments, the apparatus may further include means for receiving, in response to displaying the one or more visualizations, an indication of a request from a user to modify a first visualization of the one or more visualizations, means for modifying the first visualization based on the received indication, and means for causing display of the altered first visualization.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having thus described certain example embodiments of the present disclosure in general terms, reference will now be made to the accompanying drawings, which are not necessarily drawn to scale, and wherein:

FIG. 1 is a block diagram of an example computing device that may comprise or be utilized by example embodiments of the present invention;

FIG. 2A illustrates stages of photoelectric current generation in which an exciton travel through a donor part of a material to the nearest interface, in accordance with some example embodiments of the present invention;

FIG. 2B illustrates an example shape of charge paths through a BHJ, in accordance with some example embodiments of the present invention;

FIG. 2C illustrates a correlation between the density rate of change at each path integrated over a local area, in accordance with some example embodiments of the present invention;

FIG. 3 illustrates an example work flow of data management and visual exploration, in accordance with some example embodiments of the present invention;

FIG. 4 illustrates an example visualization of the structure local feature extraction used for computing bottlenecks; and

FIG. 5 illustrates a flow chart including example operations performed by a computing device to model and visualize properties of a material, in accordance with some example embodiments of the present invention.

### DETAILED DESCRIPTION

Some embodiments of the present invention will now be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

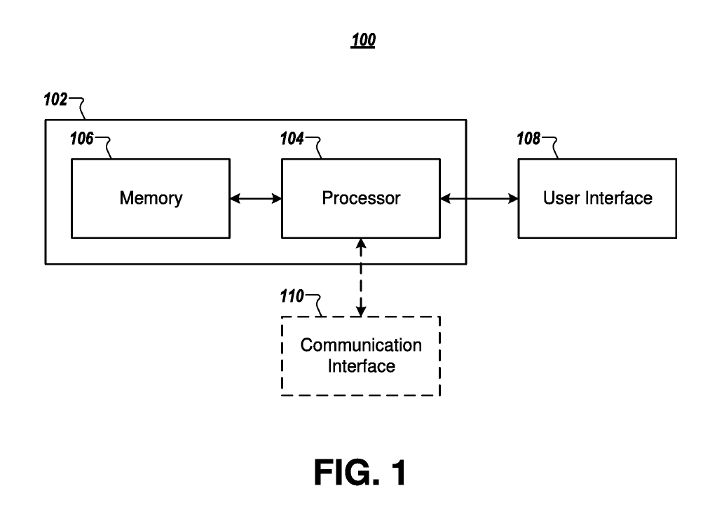

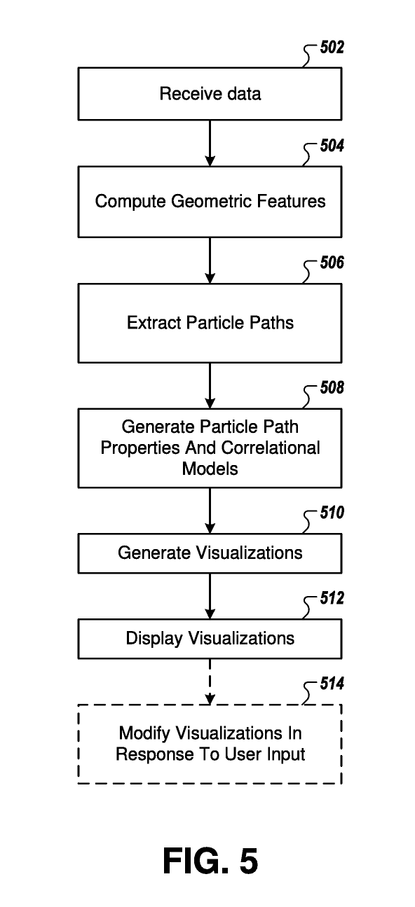

Computing Platform FIG. 1 shows a computing device 100 that may perform the operations described herein for enhancing the modeling of new materials and visualization of properties of these materials. It is contemplated that the computing device 100 may be configured to perform various operations in accordance with example embodiments of the present invention, such as in conjunction with the operations described in conjunction with FIG. 5 below. It should be noted that the components, devices, and elements described herein may not be mandatory in every embodiment of the computing device 100, and some may be omitted in certain embodiments. Additionally, some embodiments may include further or different components, devices or elements beyond those shown and described herein.

As shown in FIG. 1, the computing device 100 may include or otherwise be in communication with a processing system including, for example, processing circuitry 102 that is configurable to perform actions in accordance with example embodiments described herein. The processing circuitry 102 may be configured to perform data processing, application execution and/or other processing and management services according to an example embodiment of the present invention. In some embodiments, the computing device 100 or the processing circuitry 102 may be embodied as a chip or chip set. In other words, the computing device 100 or the processing circuitry 102 may comprise one or more physical packages (e.g., chips) including materials, components and/or wires on a structural assembly (e.g., a baseboard). The computing device 100 or the processing circuitry 102 may, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 102 may include a processor 104 and memory 106 that may be in communication with or otherwise control a user interface 108 and, in some cases, a communication interface 110. As such, the processing circuitry 102 may be embodied as a circuit chip (e.g., an integrated circuit chip) configured (e.g., with hardware or a combination of hardware and software) to perform operations described herein. In some embodiments, the processing circuitry 102 may be embodied as a portion of a communication device 102, or as a portion of an access point 104.

The processor 104 may be embodied in a number of different ways. For example, the processor 104 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor 104 may be configured to execute program code instructions stored in the memory 106 or otherwise accessible to the processor 104. As such, whether configured by hardware or by a combination of hardware and software, the processor 104 may represent an entity (e.g., physically embodied in circuitry) capable of performing operations according to embodiments of the present invention while configured accordingly. Thus, for example, when the processor 104 is embodied as an ASIC, FPGA or the like, the processor may include specifically configured hardware for conducting the operations described herein. Alternatively, as another example, when the processor 104 is embodied as an executor of software instructions, the instructions may specifically configure the processor 104 to perform the operations described herein.

The memory 106 may include one or more non-transitory memory devices such as, for example, volatile and/or non-volatile memory that may be either fixed or removable. The memory 106 may be configured to store information, data, applications, instructions or the like for enabling the computing device 100 to carry out various functions in accordance with example embodiments of the present invention. For example, the memory 106 could be configured to buffer input data for processing by the processor 104. Additionally or alternatively, the memory 106 could be configured to store instructions for execution by the processor 104. As yet another alternative, the memory 106 may include one of a plurality of databases that may store a variety of files, contents or data sets. Among the contents of the memory 106, applications may be stored for execution by the processor 104 in order to carry out the functionality associated with each respective application. In some cases, the memory 106 may be in communication with the processor 104 via a bus for passing information among components of the computing device 100.

The user interface 108 may be in communication with the processing circuitry 102 and may receive an indication of user input and/or provide an audible, visual, mechanical or other output to the user. As such, the user interface 108 may include, for example, a keyboard, a mouse, a joystick, a display, a touch screen, a microphone, a speaker, or any other input/output mechanisms.

The communication interface 110 (if implemented) may include one or more interface mechanisms for enabling communication with other devices and/or a network. In some cases, the communication interface may be any means such as a device or circuitry embodied in either hardware, or a combination of hardware and software that is configured to receive and/or transmit data from/to any other device or module in communication with the processing circuitry 102, such as between the computing device 100 and an external storage medium (e.g., a USB key, CD, DVD, external hard drive, or the like), between computing device 100 and one or more other computing devices connected via a wired or a wireless pathway, such as a local area network (e.g., an organizational intranet), or a wide area network (e.g., the Internet). In this regard, the communication interface may include, for example, an antenna (or multiple antennas) and may support hardware and/or software for enabling communications with a wireless communication network and/or a communication modem or other hardware/software for supporting communication via cable, digital subscriber line (DSL), universal serial bus (USB), Ethernet or other methods. The computing device 100 need not always include a communication interface 110. For example, in instances in which the computing device 100 contains a local copy of the data being modeled and visualized, a communication interface 110 may not be necessary. As such, the communication interface 110 is shown in dashed lines in FIG. 1.

### Context for Modeling and Visualization

As described above, example embodiments of the present invention provide visualization tools that overcome the above defects and that can be used to enhance the modeling and analysis of materials whose design is correlated to the path features of the particles flowing inside. Example embodiments described herein are contemplated for studying materials that require the analysis of the correlation between structure features and particle-path features. Some examples of domains that can make use of these embodiments include photovoltaics, semiconductors, membranes, porous and vascular data.

As described herein, example embodiments present a workflow that enables the implementation of new visualization modules—as well as existing ones—in the analysis of materials in these varieties of domains. Example embodiments are described using a particular domain science example of Organic Photovoltaic solar cells (OPVs). Although the paradigm is described in great detail below in connection with the OPV application, it can be used in many other domains without departing from the spirit or scope of the present invention.

### Example Modeling and Visualization Techniques

OPVs fabricated from polymers or small molecules represent a promising low cost, low weight, flexible alternative for harnessing solar energy. However, OPVs present some challenges that hinder their competition with other solar technologies. Key challenges include low efficiency and short life time.

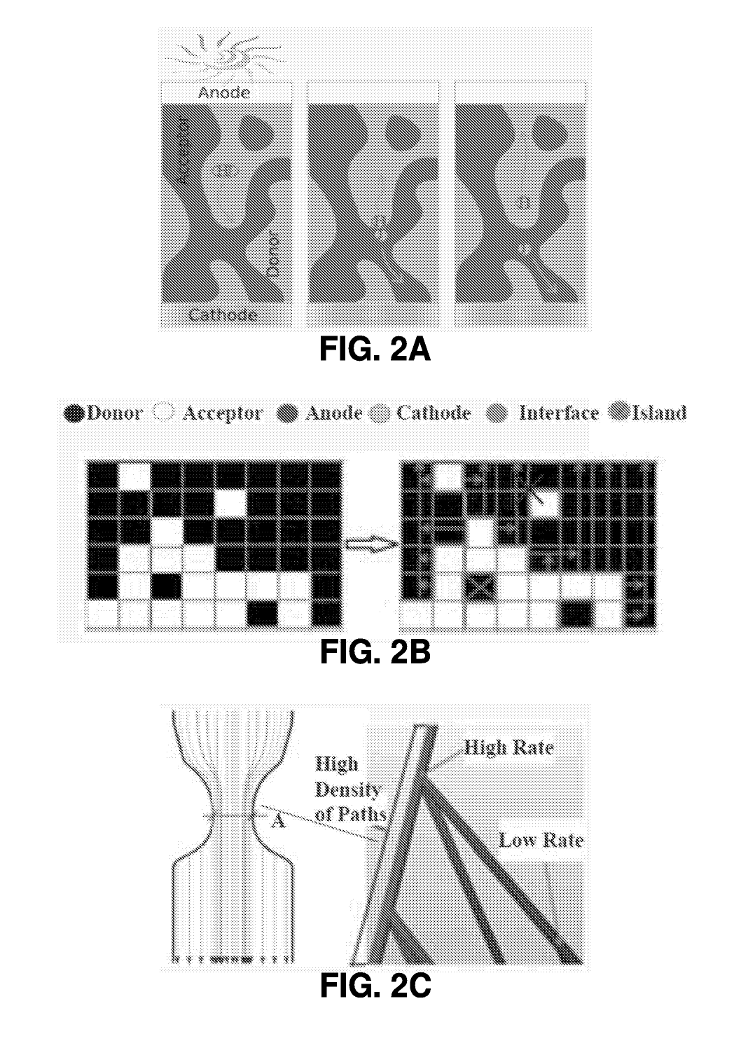

There are several approaches to address these challenges that have resulted in varying degrees of success. One promising approach to improving efficiency is through the control of the effective material of the OPV device—known as Bulk Heterojunction (BHJ) morphology—during fabrication. The morphology typically has a very complex intermixed structure with hierarchical structures spanning several length scales. Understanding and tailoring morphology is crucial because the photovoltaic process occurs in a sequence of stages (exciton generation, exciton diffusion, charge separation, charge transport, and charge collection) as illustrated in FIG. 2A, with each stage critically affected by the morphology. More importantly, some of these stages have conflicting requirements on morphology (small versus large domains, small versus large surface area) for enhanced stage wise performance. This is further exacerbated by the fact that failure at any stage of the process or any location of the morphology can have significant impact on the performance of the devices. Therefore it is imperative to detect, quantify and prioritize potential bottlenecks in the morphology.

This has to be done by taking into account the multistage nature of the underlying physics as well as the complexity of the active layer of the device. In particular, visualizing features of interest and correlating them with physics-based quantities enables better understanding of the complex interplay between individual stages and the morphology.

Application of example embodiments of the present invention to the OPV use case meets these challenges and illustrating the power of these embodiments. In this example, such applications focus on the following objectives (i) building a multi scale, multi-stage strategy for morphology quantification based on the analysis of the local features, (ii) using local features to detect bottlenecks, and finally (iii) mapping bottlenecks to geometric features. By meeting these objectives, example embodiments constitute a novel data-driven visual exploration paradigm that enhances our understanding of the effect of morphology on device performance.

As described below, example embodiments of the present invention facilitate gaining quick insight about design options through the use of a set of new geometric modeling and segmentation methods that derive the model, and perform the visual encoding. The visualization work flow involves a mixture of views that include volume rendering, line ray tracing, 2D scatter plots, and interactive transfer functions. Moreover, example embodiments allow users to interactively explore the visualizations by attributes brushing of scatter plots and spatial selection through point probes. Example embodiments also enable correlation analysis through different levels of data filtering.

From FIGS. 2A through 2C, it can be seen that charge flow can be fully represented as a flux through the morphology. The pattern of this flux is governed by the morphology texture. For simplicity, we will refer from now on to the holes transport only; since the analysis of the electrons transport is analogous.

We deal with the following input data:

Morphology volumes: each BHJ is represented by an array of voxels with acceptor volume fraction value, φ, assigned to each voxel. The value of this fraction changes between 0 and 1. By tracing the distribution of these variables, individual phases can be identified, domains with φ=0 corresponds to a pure donor, while φ=1 corresponds to a pure acceptor, respectively. In the regions separating individual phases, the volume fraction changes smoothly across the thin interface. By reconstructing the iso-contour corresponding to the iso-value 0.5, the interface can be identified. This interface is used in the subsequent analysis.

Charge paths from graphs: as described herein, an equivalence is used between voxel-wise data and a graph to effectively characterize the morphology. By translating the discrete morphology into a graph, traditional graph algorithms are used to find the shortest paths and connected components. In particular, the focus in this regard is on the shortest paths that charges take to reach the electrode. This can be identified using Dijkstra's algorithm to determine the path and its length. Effectively, for each voxel, the list of vertices constituting the shortest path to the respective electrode can be constructed. These shortest paths are used in the subsequent analysis.

Charge Transport Bottlenecks

Once charges are separated at the interface, they travel along the corresponding material domain to reach the electrode. The topology of a given domain constitutes “highways” for these paths. Whenever there is a bottleneck—either due to smaller cross sectional area on the way, or because the flux of charges is locally higher—charges may accumulate and eventually recombine. Identify bottlenecks requires investigation of changes in flux density. The bottleneck coefficient κ may be defined as the instantaneous rate of change of the flux density along a path s as illustrated in FIG. 2C:

$$κ ( s ) = \frac{dj ( s )}{d ( s )} , \qquad ( 1 )$$

where j(s) is the scalar flux density function on the path s. The bottleneck coefficient κ(s) is the derivative of this function (e.g., its slope at each location s).

The flux density at any desired location s can then simply be obtained via integration:

$$j ( s ) = j ( s ) + {\int }_{0}^{s} κ ( t ) d ( t ) , \qquad ( 2 )$$

where j(0) is the flux density at position s=0.

Characterizing whole neighborhoods with respect to their being a bottleneck requires integrating the bottleneck coefficient κ over the neighborhood. Considering a cross-sectional surface S as the neighborhood (as illustrated in FIGS. 2A through 2C), we obtain the corresponding total bottleneck value K(S) as the surface integral of the gradient of the flux projected on the surface normal, normalized by the area A of S:

$$K ( S ) = \frac{1}{A} {\int }_{S} ∇ j \cdot dS , \qquad ( 3 )$$

where dS=ndS is the differential vector area with normal vector n.

In case the direction of the flux is not required, and only the density rate of change needs to be considered, the next equation is used.

$$K ( S ) = \frac{1}{A} {\int }_{S} ‖ ∇ j ‖ dS , \qquad ( 4 )$$

The bottlenecks may then be analyzed according to the histogram of K(S), where:

K(S)>0 indicates a bottleneck

K(S)=0 indicates no bottleneck

By studying the histogram of K(S), it is possible to determine the global distribution of high and low bottlenecks.

Paths Optimal Lengths Indicator

Ideally the paths should be straight without any obstacles along them. The more curly the paths are, the more likely it is that charges will recombine or accumulate in local bottlenecks. To assess the quality of a path, embodiments may utilize tortuosity of the path as an indicator. To do this requires determining the length of shortest path from any point of donor material to the electrode, L, and relating it to the ideal path length, C, (the length of the straight line between the ends of the path without any constraints).

$$τ = \frac{L}{C} , \qquad ( 5 )$$

where:

L: the arc length (the actual path length)

C: the chord length (the ideal length)

Locating large zones with high tortuosity enables identification of regions in the BHJ that potentially require improvements. These may serve as points of focus for subsequent morphology optimization.

Exciton Diffusion Performance Indicator W(d)

The probability of an exciton reaching an interface W(d) is given by

$$W ( d ) = {e}^{\frac{- d}{{L}_{d}}} , \qquad ( 6 )$$

where:

d: the shortest distance from any point in the donor part to the interface.

L_{d}: exciton diffusion length, (materials specific quantity, 10 nm is used in the current paper) The weighting function, w, encodes the underlying physics of the exciton diffusion. In particular, W(d) reflects the limited life time of exciton, during which it can travel only certain distance before recombining (electron returns to the ground state). Weighting function quantitatively assess this based on d: the longer is the distance to the interface, the lower is the probability of reaching the interfaces. By finding the shortest path to the interface and estimating the probability of reaching the interface, embodiments described herein provide insight into this stage performance. This process is repeated for every voxel in the morphology.

Preprocessing and Visual Encoding

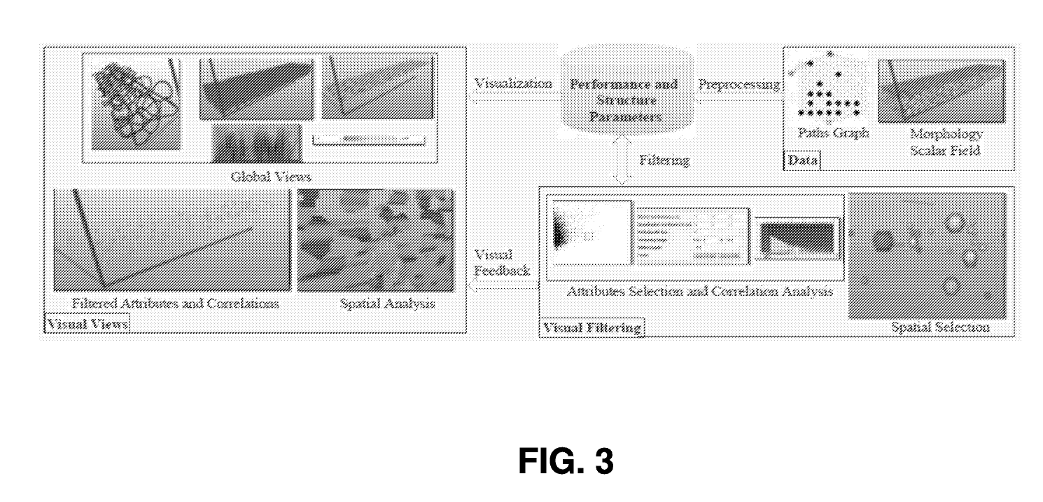

Subsequently, embodiments described herein compute the structure and performance features that are needed to implement the model discussed above. These features can be efficiently stored in pre-computed data structures to reduce computations needed in the visual exploration, as illustrated in FIG. 3.

These features can further be efficiently stored in pre-computed data structures data structures to suit the multi-modal nature of the problem—summarized in Table 1 and Table 2 below. Then the feature can be registered to the same coordinates to allow efficient computation and correlation analysis discussed in the next sections.

TABLE 1
Summary of the parameter data structures.

| Data | Structure | Description |
|---|---|---|
| V1 | 3D Texture | Sizes of local areas per |
| | | voxel |
| V2 | 3D Texture | Paths density per voxel |
| V3 | 3D Texture | Forward derivative of paths |
| | | density per voxel |
| V4 | 3D Texture | Bottlenecks per voxel |
| V5 | 3D Texture | L_{d} distance map per voxel |
| G_{backbone} | Spatial Graph | The back bone graph |
| Lₚₐₜₕ | Line topology | The line of a path segment |

TABLE 2
Summary of the attributes and the relevant data structures.

| Attribute Name | Assigned to | Description |
|---|---|---|
| V1_{attrib} | G_{backbone} | Sizes of local areas per |
| | | backbone point |
| V2_{attrib} | Lₚₐₜₕ | Paths density per line point |
| V3_{attrib} | Lₚₐₜₕ | The derivatives per line |
| | | point |
| V4_{attrib} | G_{backbone} | Bottleneck per backbone |
| | | point |
| V5_{attrib} | G_{backbone} | Ld per backbone point |
| T_{attrib} | Lₚₐₜₕ | The tortuosity of the whole |
| | | line segment |

Structure Segmentation

In order to compute K(S) in a meaningful way, one must determine the surface S around each voxel j, such that it reflects the size of the local neighborhood. Accordingly, example embodiments utilize a segmentation technique that places a boundary between segments whenever the routes through the morphology get narrower. Then, these example embodiments compute cross sectional areas from those segments.

Segmentation based on distance maps: The first step in the segmentation pipeline is the computation of the signed distance map, starting from all interface voxels. In this regard, example embodiments use the Euclidean distance metric. If the distance map inside the regions of interest have negative signs, this distance field is used. Otherwise, the distance field is inverted. Example embodiments apply a watershed algorithm and subsequently apply a persistence-based merging step to create larger regions. Doing so involves comparing the scalar maxima of two regions to be merged with the scalar value at the potential merge point. If the difference between one of the maxima and the scalar value at the merge point is below a used-defined threshold, the regions are merged. Otherwise, the regions are not merged.

Domain Size Computation

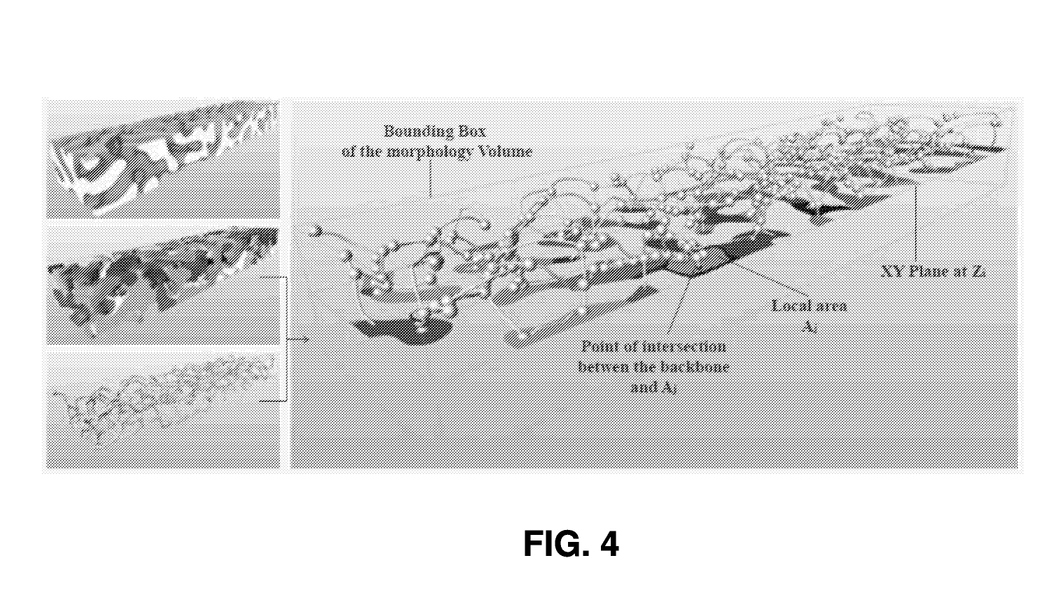

After the segmentation, local areas are extracted by sliding an XY plane over the Z axis. For every value zᵢ, the algorithm finds the intersection between every segment and the XY plane as illustrated in FIG. 4. The size of the area is the number of pixels (nm²) that belong to the intersection area Aⱼ. We store this area as V1; every voxel that belongs to Aⱼ is assigned the size of the area.

Computing Performance Indicators

After extracting the local areas and determining their sizes, the parameters for computing bottlenecks become ready. Computing the bottlenecks utilizes both the volume data and the charges paths graph data discussed above.

K(S): First, Equation 1 is realized by retrieving and counting the number of paths that visit each voxel and storing this density in V2. Then Equation 2 is computed by retrieving all the paths and finding the derivative by forward differencing of the density along each path (fetched from V2), and storing the derivative in V3. Finally, K(Sⱼ) is found by integrating the derivatives that belong to Sⱼ and storing the bottleneck at each voxel that belong to Sⱼ.

T(L: Whenever the tortuosity is requested, the relevant charge line segment L is retrieved on the fly by a trivial random walk on the charge paths graph.

W(d): First L_{d} is computed at a certain voxel from the distance map in the donor part with respect to the interface. Then, the distance value is stored in V5 for every voxel. Finally, W(d) is found at each voxel by fetching the distance value and computing Equation 6.

The Morphology Backbone

In order to visualize the connectivity between the segments, example embodiments utilize the following backbone data structure. The idea of the backbone is based on the fact that every area Aⱼ can be represented by the point at its center of gravity as shown in FIG. 4. The backbone is preprocessed and stored in the data structure G_{backbone}={Point, Edge, Vertex, Attributes}, where: the point is the center of gravity, the edge is the connection between two successive points, the vertex is the branching hub, and the attributes are the features values at this point. The coordinates of the backbone are then registered to the volume data. Thus, the attributes can be directly fetched from the corresponding volume at the same location. By color coding the backbone with the attribute value under exploration, example embodiments provide a less cluttered and smart summary of many of the structure and performance features that characterize the whole morphology.

Visualization

The visual exploration workflow is illustrated in FIG. 3. Example embodiments provide three stages of analysis. Initially, the user performs quick analysis of morphologies data sets in hand through comparing global views. If the data is too cluttered, they explore abstract, and/or filtered views. Users can further zoom in to local regions of interest and explore all details of structure, performance and paths features. Since OPV design is of concern, characterizations may also be created through correlation analysis. High level correlation exploration can incorporate expert knowledge and help scientists to derive intuition. This exploration feature is crucial since the OPV design is still in the early stages of understanding. The details of the main visualization views and interactivity aids used to implement the visual exploration workflow are described next.

Volumes View

Volumes listed in Table 1 may be visualized using conventional volume rendering and one dimensional transfer functions methods. Moreover, filtered volume rendering views may also be enabled, where the user can filter a certain volume into patches or points that fall in interactively selects attributes domains.

Backbone View

The backbone view allows the user to render the pre-computed G_{backbone}. The backbone is mainly displayed as follows: the vertices as spheres and the edges as lines/tubes/points of interactive sizes. The user may interactively apply a one dimensional transfer function to color code the graph with respect one of the attributes listed in Table 2. The attributes are directly selected through GUI widgets.

Charge Paths View

The user may render paths as lines or tubes. The user also may visualize color coded attributes. Moreover, the user can display bundles of paths that pass through one point or a certain set of points falling through a square area. Furthermore, the user can visualize only the segments that fall within a certain length around a certain point. The user may interactively select the point, the bundle area size, and the filtering length through a dedicated GUI.

Interactive Analysis

The current application involves multi-attribute analysis in both the temporal and spatial domains. This provides a big challenge in finding correlations of interest. To facilitate fast exploration, the following two methods are also provided.

Attributes Brushing: example embodiments plot the attributes correlation against other each in two dimensional scatter plots. Each point in the scatter plot represents one local area Aⱼ normally selected to be the point on the backbone. Through GUI widgets, the user selects the two attributes to be plotted (from the backbone attributes in Table 2). Then, the attribute values are mapped to a pixel position in the scatter plot. This way, correlations between two attributes can be explored quickly The scatter plots discussed earlier may be expanded with selection widgets to select ranges of parameters in a certain volume—from Table 1—selected by the user through the GUI. The widget is represented by a small square interactively positioned by the user. The small square brushes the points in the selected volume that fall in the attributes values within. This allows the user to produce volumes filtered only by attributes of interest, and hence provides a third level of correlation.

Spatial Analysis

The user performs spatial analysis through point probes. A point probe consists of two orthogonal lines and a sphere in the middle. The user can interactively position this sphere at any point and retrieve the coordinates at this point with respect to the morphology volume. The user then uses these coordinates to perform different types of spatial analysis, such as: (1) retrieving a set of paths that pass through a point, (2) retrieving a set of paths that pass through a neighbor area around the point, or (3) retrieving a region of interest in the volume around this volume and exploring its local structure features. The region of interest can be visualized as a sub-volume, two dimensional slice, or multiple superimposed two dimensional slices.

These example embodiments illustrate provide three novel contributions to allow helpful analysis for this new domain of science. First, these example embodiments illustrate the new concepts of: (1) evaluating local bottlenecks; (2) allowing a new abstraction model for the complex BHJ morphologies that summarizes a lot of information correlated to each other in a less cluttered view, and (3) enabling a data-driven method for building intuitions about BHJ design vs. methods based on previous assumptions. The traditional analysis work flow depends on lab experiments and time consuming simulations that produce a large set of multidimensional/multi-attribute and multi-modal statistics to analyze. This makes such traditional systems impractical for analysis based on trial and error or even using conventional analysis techniques. Example embodiments further allow for fast exploration, which helps to provide fast initial guesses and hence reduce the analysis time significantly. Furthermore, given the discrete nature of the charge paths, using a less approximate model for the charge paths graph or dealing directly with simulation data or vector fields can improve continuity of visualizations of bottlenecks and the derivatives.

### Operations Performed to Implement Example Modeling and Visualization Techniques

Having stepped through an example embodiment relating to OPV materials design, FIG. 5 illustrates a flowchart containing a series of operations performed by example embodiments described herein to model a material and display visualizations illustrating properties of the material. The operations shown in FIG. 5 are performed in an example embodiment by an apparatus 100 that may be embodied by or otherwise associated with processing circuitry 102 (which may include a processor 104 and a memory 106), a user interface 108, and in some embodiments, a communication interface 110.

In operation 502, the computing device 100 includes means, such as processing circuitry 102, user interface 108, communication interface 110, or the like, for receiving data describing a set of properties of a material. In some embodiments, receiving the data describing the material includes receiving a data file including information describing geometric characteristics of the material. In such embodiments, computing the geometric features of the material is based on the received data file. In some embodiments, receiving the data describing the material includes receiving user input regarding at least one property of the set of properties of the material. In these embodiments, computing the geometric features of the material is based on the received user input. In some embodiments, the received data may comprise both a data file including information describing geometric characteristics of the material and user input regarding at least one property of the set of properties of the material. In these embodiments, computing the geometric features of the material is based on both the received data file and the received user input.

Moreover, it should be understood that communication interface 110 may be utilized to perform operation 502 because the data may be received via a separate device (e.g., an external storage medium or a networked computing device). However, in embodiments where the data is received from within the computing device 100 itself (e.g., the data had previously been stored in memory 106), no communication interface 110 will be needed to perform the subsequent operations described herein.

In operation 504, the computing device 100 includes means, such as processing circuitry 102 or the like, for computing, based on the received data, geometric features of the material. To this end, computing the geometric features of the material may include at least one of: generating a distance map between geometric features of the material; generating a two dimensional segmentation representing geometric features of the material; generating a three dimensional segmentation representing geometric features of the material; generating a morphology backbone data structure that identifies geometric features of the material; or identifying cross-sectional areas comprising geometric features of the material. These computations are described in greater detail above.

In operation 506, the computing device 100 includes means, such as processing circuitry 102 or the like, for extracting particle paths within the material based on the computed geometric features. It should be understood that a charge path (as discussed above) is one type of particle path that might be extracted, in some embodiments. In this regard, this operation may apply Dijkstra's algorithm, as mentioned previously. For instance, extracting the particle paths may include generating a graph structure including nodes representative of the geometric features of the material, and computing a set of shortest paths between nodes in the graph structure. The particle paths are the set of shortest paths between the nodes. Of course, other ways of calculating the shortest paths between nodes are contemplated without departing from the spirit or scope of the present invention. For instance, rather than calculating the global shortest paths exhaustively, alternative heuristics may be used to approximate a calculation of these shortest paths, in which case such approximations may be possible to compute much more quickly.

In operation 508, the computing device 100 includes means, such as processing circuitry 102 or the like, for geometrically modeling the material using the geometric features and the extracted particle paths. In this regard, geometrically modeling the material may include deriving at least one set of direct features of the material, and generating correlational models illustrating properties of the material. As described previously, deriving the at least one set of direct features of the material may include at least one of: calculating lengths of particle paths within the material; calculating tortuosity of particle paths within the material; calculating sizes of cross-sectional areas of geometric features of the material; or any combination thereof. Generating correlational models illustrating properties of the material, on the other hand, may include at least one of: generating a bottleneck model describing bottleneck coefficients associated with cross-sections of the extracted particle paths, generating an exciton diffusion model describing probabilities that excitons diffuse from a donor part of the material to an interface with an acceptor part of the material via the extracted particle paths; or both generating a bottleneck model and generating an exciton diffusion model.

In operation 510, the computing device 100 includes means, such as processing circuitry 102, user interface 108, or the like, for generating, based on the geometric modeling of the material, one or more visualizations regarding the material. In various embodiments, the one or more visualizations may include a spatial graph illustrating a backbone topology, a scatter plot illustrating correlations between geometric features, a spatial graph illustrating a particle path topology, or any combination thereof.

Subsequently in operation 512, the computing device 100 includes means, such as by processing circuitry 102, user interface 108, communication interface 110, or the like, for causing display of the one or more visualizations. In this regard, the computing device 100 may include a user interface 108 that displays the one or more visualizations. In some embodiments, however, the computing device 100 is a remote device that operates in response to input from a separate computing device operated by a user. In such embodiments, the communication interface 110 may transmit the one or more visualization to the separate computing device operated by the user for subsequent display.

From operation 512, the procedure may optionally advance to operation 514, in which the computing device 100 includes means for modifying the displayed visualizations. In this regard, the computing device 100 may include means, such as processing circuitry 102, user interface 108, communication interface 110, or the like, for receiving, in response to displaying the one or more visualizations, an indication of a request from a user to modify a first visualization of the one or more visualizations. Subsequently, the computing device 100 includes means, such as processing circuitry 102 or the like, for modifying the first visualization based on the received indication. Finally, the computing device 100 includes means, such as processing circuitry 102, user interface 108, communication interface 110, or the like, for displaying the altered first visualization. As noted above with operations 502 and 512, in embodiments in which the computing device 100 is a separate device from that operated by a user, then the communication interface 110 may receive the request from and transmit the altered visualizations to the separate computing device operated by the user.

Accordingly, the operations illustrated in FIG. 5 provide a paradigm that enhances the modeling and analysis of materials whose design is correlated to the path features of the particles flowing inside. This paradigm overcomes obstacles associated with prior visualization paradigms, because, among other things, it uses a novel mechanism for extracting particle paths; it is configured to calculate features associated with those particle paths (when extracted), it provides visualization modules that support analysis of this type of data, and, by simplifying the geometric features representative of the material, the computations are both accurate and can be performed efficiently enough to enable computer systems to support interactive visual exploration of these particle paths and their correlations to the extracted structure features.

The above-described flowchart illustrate operations performed by communication device 102 (which include the hardware elements of computing device 100 of FIG. 1), in accordance with some example embodiments of the present invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by program code instructions. In this regard, the program code instructions which embody the procedures described above may be stored by a memory 106 of the computing device 100 employing an embodiment of the present invention and executed by a processor 104 of the computing device 100. As will be appreciated, loading these program code instructions onto a computing device 100 produces a specially programmed apparatus configured to implement the functions specified in the respective flowchart blocks. The program code instructions may also be stored in a non-transitory computer-readable storage medium that may direct a computer or other programmable apparatus to function in the prescribed manner, such that storing the program code instructions in the computer-readable storage memory produce an article of manufacture which can be accessed by an computing device 100 to implement the functions specified in the flowchart blocks. Accordingly, the operations illustrated in the flowchart define algorithms for configuring a computer or processing circuitry 102 (e.g., a processor) to perform example embodiments described above. When a general purpose computer stores the algorithms illustrated above, the general purpose computer is transformed into a particular machine configured to perform the corresponding functions.

Blocks of the flowchart support combinations of means for performing the specified functions and combinations of operations for performing the specified functions. It will be understood that one or more blocks of the flowchart, and combinations of blocks in the flowchart, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method comprising:
receiving data describing a set of properties of a material;
computing, by a processor and based on the received data, geometric features of the material;
extracting, by the processor, particle paths within the material based on the computed geometric features;
geometrically modeling, by the processor, the material using the geometric features and the extracted particle paths;
generating, by the processor and based on the geometric modeling of the material, one or more visualizations regarding the material; and
causing display, by a user interface, of the one or more visualizations.

2. The method of claim 1, wherein receiving data describing the material comprises:
receiving a data file including information describing geometric characteristics of the material,
wherein computing the geometric features of the material is based on the received data file.

3. The method of claim 1, wherein receiving data describing the material includes:
receiving user input regarding at least one property of the set of properties of the material,
wherein computing the geometric features of the material is based on the received user input.

4. The method of claim 1, wherein computing the geometric features of the material comprises at least one of:
generating a distance map between geometric features of the material;
generating a two dimensional segmentation representing geometric features of the material;
generating a three dimensional segmentation representing geometric features of the material;
generating a morphology backbone data structure that identifies geometric features of the material; or
identifying cross-sectional areas comprising geometric features of the material.

5. The method of claim 1, wherein extracting the particle paths comprises:
generating a graph structure including nodes representative of the geometric features of the material; and
computing a set of shortest paths between nodes in the graph structure,
wherein the particle paths comprise the set of shortest paths between the nodes.

6. The method of claim 1, wherein geometrically modeling the material comprises:
deriving at least one set of direct features of the material; and
generating correlational models illustrating properties of the material.

7. The method of claim 6, wherein deriving the at least one set of direct features of the material includes at least one of:
calculating lengths of particle paths within the material;
calculating tortuosity of particle paths within the material; or
calculating sizes of cross-sectional areas of geometric features of the material.

8. The method of claim 6, wherein generating correlational models illustrating properties of the material includes at least one of:
generating a bottleneck model describing bottleneck coefficients associated with cross-sections of the extracted particle paths; or
generating an exciton diffusion model describing probabilities that excitons diffuse from a donor part of the material to an interface with an acceptor part of the material via the extracted particle paths.

9. The method of claim 1, wherein generating the one or more visualizations comprises generating at least one of:
a spatial graph illustrating a backbone topology;
a scatter plot illustrating correlations between geometric features; or
a spatial graph illustrating a particle path topology.

10. The method of claim 1, further comprising:
receiving, in response to displaying the one or more visualizations, an indication of a request from a user to modify a first visualization of the one or more visualizations;
modifying the first visualization based on the received indication; and
causing display, by the user interface, of the altered first visualization.

11. An apparatus comprising a processor and a memory storing program code instructions that, when executed by the processor, cause the apparatus to:
receive data describing a set of properties of a material;
compute, based on the received data, geometric features of the material;
extract particle paths within the material based on the computed geometric features;
geometrically model the material using the geometric features and the extracted particle paths;
generate, based on the geometric modeling of the material, one or more visualizations regarding the material; and
cause display of the one or more visualizations.

12. The apparatus of claim 11, wherein receiving data describing the material comprises:
receiving a data file including information describing geometric characteristics of the material, wherein computing the geometric features of the material is based on the received data file; or
receiving user input regarding at least one property of the set of properties of the material, wherein computing the geometric features of the material is based on the received user input.

13. (canceled)

14. The apparatus of claim 11, wherein the program code instructions, when executed by the processor, cause the apparatus to compute the geometric features of the material by at least one of:
generating a distance map between geometric features of the material;
generating a two dimensional segmentation representing geometric features of the material;
generating a three dimensional segmentation representing geometric features of the material;
generating a morphology backbone data structure that identifies geometric features of the material; or
identifying cross-sectional areas comprising geometric features of the material.

15. The apparatus of claim 11, wherein the program code instructions, when executed by the processor, cause the apparatus to extract the particle paths by:
generating a graph structure including nodes representative of the geometric features of the material; and
computing a set of shortest paths between nodes in the graph structure,
wherein the particle paths comprise the set of shortest paths between the nodes.

16. The apparatus of claim 11, wherein the program code instructions, when executed by the processor, cause the apparatus to geometrically model the material by:
deriving at least one set of direct features of the material; and
generating correlational models illustrating properties of the material.

17. The apparatus of claim 16, wherein the program code instructions, when executed by the processor, cause the apparatus to derive the at least one set of direct features of the material by at least one of:
calculating lengths of particle paths within the material;
calculating tortuosity of particle paths within the material; or
calculating sizes of cross-sectional areas of geometric features of the material.

18. The apparatus of claim 16, wherein the program code instructions, when executed by the processor, cause the apparatus to generate correlational models illustrating properties of the material by at least one of:
generating a bottleneck model describing bottleneck coefficients associated with cross-sections of the extracted particle paths; or
generating an exciton diffusion model describing probabilities that excitons diffuse from a donor part of the material to an interface with an acceptor part of the material via the extracted particle paths.

19. The apparatus of claim 11, wherein the program code instructions, when executed by the processor, cause the apparatus to generate the one or more visualizations by generating at least one of:
a spatial graph illustrating a backbone topology;
a scatter plot illustrating correlations between geometric features; or
a spatial graph illustrating a particle path topology.

20. The apparatus of claim 11, wherein the program code instructions, when executed by the processor, further cause the apparatus to:
receive, in response to displaying the one or more visualizations, an indication of a request from a user to modify a first visualization of the one or more visualizations;
modify the first visualization based on the received indication; and
cause display of the altered first visualization.

21. A non-transitory computer readable storage medium storing program code instructions that, when executed by an apparatus, cause the apparatus to:
receive data describing a set of properties of a material;
compute, and based on the received data, geometric features of the material;
extract particle paths within the material based on the computed geometric features;
geometrically model the material using the geometric features and the extracted particle paths;
generate, based on the geometric modeling of the material, one or more visualizations regarding the material; and
cause display, by a user interface, of the one or more visualizations.
